(19) United States
(12) Patent Application Publication
(10) Pub. No.: US 2022/0311286 A1
(43) Pub. Date: Sep. 29, 2022

(54) Magnetic Alignment Systems for Wireless Power Devices

(71) Applicant: Apple Inc., Cupertino, CA (US)

(72) Inventor: Adam L. Schwartz, Redwood City, CA (US)

(21) Appl. No.: 17/669,929

(22) Filed: Feb. 11, 2022

Related U.S. Application Data
(60) Provisional application No. 63/166,771, filed on Mar. 26, 2021.

(51) Int. Cl. H02J 50/90; H02J 50/10

(52) U.S. Cl. CPC H02J 50/90; H02J 50/10; H02J 7/0044

(57) ABSTRACT

Power may be transmitted wirelessly between electronic devices. Devices such as cellular telephones, wireless charging pucks, and other equipment may have wireless power circuitry with coils. The wireless power circuitry may have inverter circuitry and rectifier circuitry. The inverter circuitry and a coil that receives alternating-current signals from the inverter circuitry may be used to transmit wireless power signals. Wireless power signals received by a coil in a mated device may be rectified using the rectifier circuitry in that device to produce direct-current power. To align first and second devices for power transfer between their coils, devices may be provided with alignment magnets. The alignment magnets may be configured to permit a first device to be mated back-to-back with a second device such as a second device of the same type as the first device.

This application claims the benefit of provisional patent application No. 63/166,771, filed Mar. 26, 2021, which is hereby incorporated by reference herein in its entirety.

### FIELD

This relates generally to power systems, and, more particularly, to wireless power systems for charging electronic devices.

### BACKGROUND

In a wireless charging system, a wireless power transmitting device wirelessly transmits power to a wireless power receiving device. Magnets may be used to align the wireless power transmitting device and wireless power receiving device with each other.

During operation, the wireless power transmitting device uses a wireless power transmitting coil to transmit wireless power signals to the wireless power receiving device. The wireless power receiving device has a coil and rectifier circuitry. The coil of the wireless power receiving device receives alternating-current wireless power signals from the wireless power transmitting device. The rectifier circuitry converts the received signals into direct-current power.

### SUMMARY

Power may be transmitted wirelessly between electronic devices. Devices such as cellular telephones, wireless charging pucks, and other equipment may have wireless power coils. Wireless power circuitry such as inverter circuitry and rectifier circuitry may be included in the devices. In one device, inverter circuitry and a coil that receives alternating-current signals from the inverter circuitry may be used to transmit wireless power signals. Wireless power signals received by a coil in a mated device may be rectified by using the rectifier circuitry of that device to produce direct-current power.

The coils in devices that transmit and receive power can be aligned magnetically. Proper operation may be ensured by aligning the coil in device that is wireless transmitting power to an overlapping coil in a device that is wirelessly receiving power.

To magnetically align and attach first and second devices for power transfer between their coils, the first and second devices may be provided with respective mating alignment magnets. The alignment magnets may be arranged in patterns such as rings.

A device may have a ring of alignment magnets bisected by an axis. The magnets on one side of the axis may have poles with positions that are a reflection of corresponding poles of opposite magnetic polarity on an opposing side of the axis. This arrangement allows a first device to be magnetically aligned and attached back-to-back with a second device of the same model or type. By permitting back-to-back mating, devices may transmit and/or receive wireless power from peer devices.

### BRIEF DESCRIPTION OF THE DRAWINGS

FIG. 1 is a schematic diagram of an illustrative wireless power system in accordance with an embodiment.

FIG. 2 is a perspective view of illustrative first and second electronic devices in a back-to-back configuration for wireless power transfer in accordance with an embodiment.

FIGS. 3, 4, 5, and 6 are schematic diagrams of alignment magnet arrangements.

FIG. 7 is a cross-sectional side view of illustrative first and second electronic devices in a back-to-back configuration for wireless power transfer in accordance with an embodiment.

FIGS. 8, 9, 10, 11, and 12 are top views of illustrative alignment magnet arrangements in accordance with embodiments.

FIG. 13 is a cross-sectional side view of illustrative alignment magnets for mating electronic devices in a back-to-back configuration for wireless power transfer in accordance with an embodiment.

FIG. 14 is a cross-sectional side view of a stack of three magnetically aligned wireless power devices such as first and second devices of the same type coupled to opposing sides of a double-sided charging puck in accordance with an embodiment.

### DETAILED DESCRIPTION

A wireless power system includes electronic devices such as wrist watches, cellular telephones, tablet computers, laptop computers, removable battery cases, electronic device accessories, wireless charging mats, wireless charging pucks, and/or other electronic equipment. These electronic devices have wireless power circuitry. For example, an electronic device may have a wireless power coil. Some devices use wireless power coils for transmitting wireless power signals. Other devices use wireless power coils for receiving transmitted wireless power signals. If desired, some of the devices in a wireless power system may have both the ability to transmit wireless signals and to receive wireless signals. A cellular telephone or other portable electronic device may, as an example, have a coil that can be used to receive wireless power signals from a charging puck or other wireless transmitting device and that can also be used to transmit wireless power to another wireless power device (e.g., another cellular telephone). A device with one or more wireless power coils that is used for transmitting and/or receiving wireless power signals may be referred to as a wireless power device. Devices with power transmitting capabilities may sometimes be referred to as wireless power transmitting devices or wireless power devices. Devices with power receiving capabilities may sometimes be referred to as wireless power receiving devices or wireless power devices.

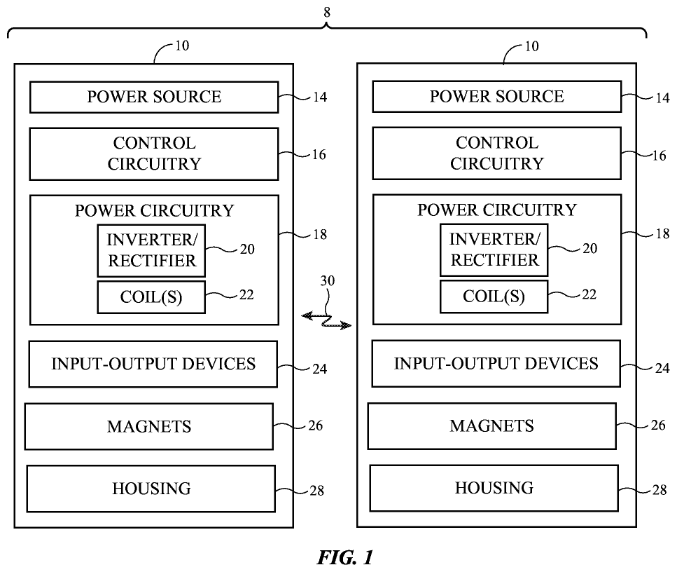

A wireless power system containing two or more wireless power devices is shown in FIG. 1. As shown in FIG. 1, wireless power system 8 may include wireless power devices 10. Each wireless power device in system 8 may include a housing 28 containing one or more components such as power source 14, control circuitry 16, power circuitry 18, input-output devices 24, and alignment magnets 26. Housing 28 may be formed from polymer, metal, glass, ceramic, other materials, and/or combinations of these materials.

Power source 14 may include an alternating-current-to-direct-current power adapter that converts wall power (mains power) from an alternating-current source to direct-current power to power the circuitry of device 10 and/or may include a source of direct-current power such as a battery. If desired, devices with batteries can be wirelessly charged by receiving wireless power signals from a wireless power transmitting device.

Control circuitry 16 in each device 10 of system 8 is used in controlling the operation of system 8. This control circuitry may include processing circuitry associated with microprocessors, power management units, baseband processors, digital signal processors, microcontrollers, and/or application-specific integrated circuits with processing circuits. The processing circuitry implements desired control and communications features in devices 10. For example, the processing circuitry may be used in processing user input, handling negotiations between devices 10, sending and receiving in-band and out-of-band data, making measurements, estimating power losses, determining power transmission levels, and otherwise controlling the operation of system 8.

Control circuitry 16 in system 8 may be configured to perform operations in system 8 using hardware (e.g., dedicated hardware or circuitry), firmware and/or software. Software code for performing operations in system 8 and other data is stored on non-transitory computer readable storage media (e.g., tangible computer readable storage media) in control circuitry 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16. The processing circuitry may include application-specific integrated circuits with processing circuitry, one or more microprocessors, a central processing unit (CPU) or other processing circuitry.

Devices 10 use power circuitry 18 to transmit and/or receive wireless power. The power circuitry of each device includes one or more coils 22. Configurations in which each device 10 has a single coil may sometimes be described herein as an example.

The power circuitry in each device includes inverter and/or rectifier circuitry such as circuitry 20 coupled to one or more coils 22. When it is desired to transmit wireless power, an inverter (e.g., an inverter in circuitry 20) in a first device is used to drive alternating-current (AC) current signals into the coil 22 that is coupled to that inverter. The AC currents signals may have any suitable frequency (e.g., 100-250 kHz, etc.). As the AC currents pass through coil 22 in the first device, alternating-current electromagnetic (e.g., magnetic) fields (wireless power signals 30) are produced that are received by a corresponding coil 22 in a second device, thereby inducing associated AC signals in the second device. These AC signals are rectified in the second device using a rectifier in circuitry 20 of the second device. The rectified output of the rectifier serves to power the circuitry of the second device (e.g., to operate internal components, to charge an internal battery, etc.).

Each device 10 in system 10 may have optional input-output devices 24. Input-output devices 24 may include input devices for gathering user input and/or making environmental measurements and may include output devices for providing a user with output. As an example, input-output devices 24 may include a display for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 24 may also include sensors for gathering input from a user and/or for making measurements of the surroundings of system 8. Illustrative sensors that may be included in input-output devices 24 include three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible cameras with respective infrared and/or visible digital image sensors and/or ultraviolet light cameras), gaze tracking sensors (e.g., a gaze tracking system based on an image sensor and, if desired, a light source that emits one or more beams of light that are tracked using the image sensor after reflecting from a user's eyes), touch sensors, buttons, capacitive proximity sensors, light-based (optical) proximity sensors such as infrared proximity sensors, other proximity sensors, force sensors, sensors such as contact sensors based on switches, gas sensors, pressure sensors, moisture sensors, magnetic sensors, audio sensors (microphones), ambient light sensors, optical sensors for making spectral measurements and other measurements on target objects (e.g., by emitting light and measuring reflected light), microphones for gathering voice commands and other audio input, distance sensors, motion, position, and/or orientation sensors that are configured to gather information on motion, position, and/or orientation (e.g., accelerometers, gyroscopes, compasses, and/or inertial measurement units that include all of these sensors or a subset of one or two of these sensors), sensors such as buttons that detect button press input, joysticks with sensors that detect joystick movement, keyboards, and/or other sensors. Each device 10 may omit some or all of devices 24 or may include one or more of devices 24.

Devices 10 in system 8 have alignment magnets 26 to facilitate magnetic attachment and alignment of a pair of devices 10 to each other. For example, each device 10 may have magnets 26 that help align that device 10 to another device so that the coils in each respective device overlap and are positioned for wireless power transfer. The use of magnets 26 for coil alignment allows power to be transferred satisfactorily between devices.

Devices 10 can communicate wirelessly using in-band or out-of-band communications. For example, devices 10 may have wireless transceiver circuitry that transmits and receives wireless out-of-band signals using antennas. In-band transmissions between devices 10 may be performed using coils 22. With one illustrative configuration, frequency-shift keying (FSK) is used to convey in-band data from a wireless power transmitting device to a wireless power receiving device and amplitude-shift keying (ASK) is used to convey in-band data from a receiving device to a transmitting device. Power may be conveyed wirelessly between devices during these FSK and ASK transmissions.

It is desirable for devices 10 to be able to communicate information such as received power, battery states of charge, stored data, measurements, and so forth, to control wireless power transfer. However, the above-described technology need not involve the transmission of personally identifiable information in order to function. Out of an abundance of caution, it is noted that to the extent that any implementation of this charging technology involves the use of personally identifiable information, implementers should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

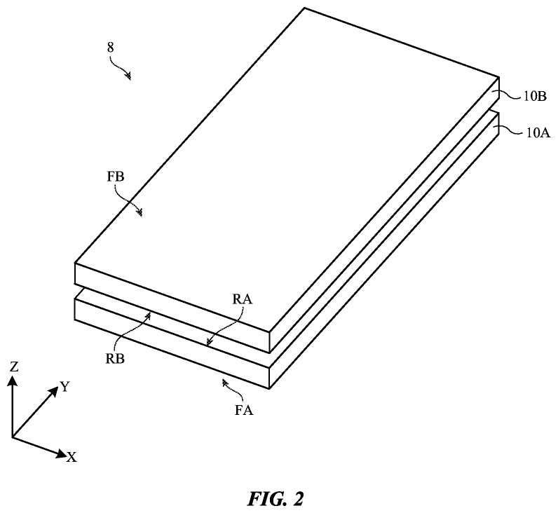

It may sometimes be desired to transfer power between two devices of the same type (e.g., first and second cellular telephones of the same model). Each device may have a coil mounted within the housing of the device. The coil may be mounted adjacent to the rear wall (back wall) of the housing and may be configured to transmit and receive wireless signals through the rear wall. The rear wall may, in an illustrative arrangement, be formed from a dielectric such as glass or polymer. When it is desired to transfer power between first and second devices, the second device may be placed on top of the first device in a back-to-back arrangement of the type shown in FIG. 2. As shown in the example of FIG. 2, first electronic device 10A has a front face (front) FA and an opposing rear face (rear or back) RA. Second electronic device 10B, which is resting on top of first device 10A in the orientation of FIG. 2, has a front face (front) FB and has an opposing rear face (rear or back) RB. When placed back-to-back to align the respective coils of devices 10A and 10B, rear faces RA and RB face each other as shown in FIG. 2. Rear faces RA and RB may, for example, contact each other when devices 10A and 10B are mated.

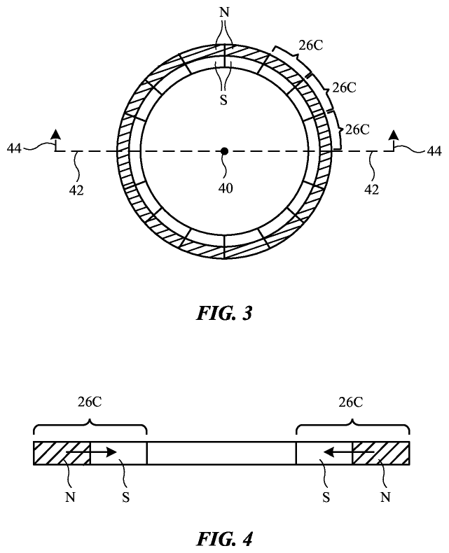

FIG. 3 is a top (front) view of electronic device alignment magnets viewed from the front face of a device. As shown in FIG. 3, magnets 26C, which each have north poles (N) and laterally adjacent south poles (S) are arranged in a ring around center 40. The designations of N (to represent north poles) and S t(o represent south poles) in FIG. 3 and the other drawings is illustrative. It will be appreciated that throughout this description these designations can be reversed with no loss of generality (e.g., in any given embodiment S can be swapped for N and vice versa).

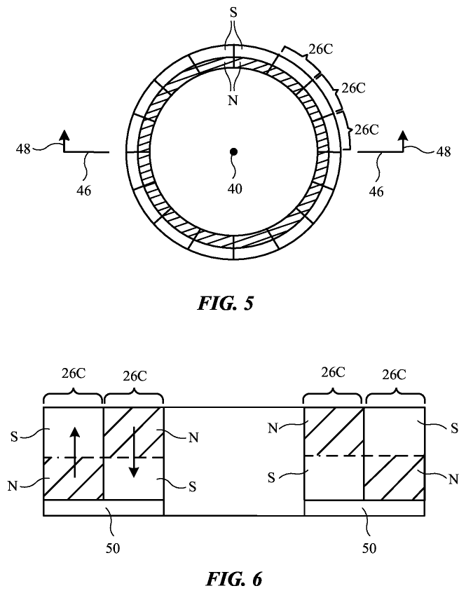

FIG. 4 is a cross-sectional side view of magnets 26C of FIG. 3 taken along line 42 of FIG. 3 and viewed in direction 44. The inwardly directed horizontal arrows in FIG. 4 and similar arrows in other drawings are used to depict magnetic polarity directions. FIG. 5 is a top (front) view of a charging puck with alignment magnets 26C. FIG. 6 is a cross-sectional side view of magnets 26C of FIG. 5 taken along line 46 of FIG. 5 and viewed in direction 48. As shown in FIG. 6, the charging puck may have vertical magnets 26C, each having a first pole stacked vertically on top of a second opposite pole. This causes magnetic flux from magnets 26C to be oriented vertically. Ferrite 50 helps confine magnetic flux at the bottoms of magnets 26C.

With the arrangement of FIGS. 3, 4, 5, and 6, the alignment magnets exhibit a magnetic pole pattern that essentially does not vary with rotation about center 40. The charging puck alignment magnets form an outer ring having poles with a south (S) magnetic polarity centered on center 40 and a concentric inner ring having poles with a north (N) magnetic polarity (see, e.g., FIG. 5). Regardless of how much the magnets are rotated about center 40, the outer ring will retain south polarity and the inner ring will retain north polarity. The electronic device magnets have similar rotationally symmetric magnetic poles but with reverse polarity. As shown in FIG. 3, magnets 26C of the electronic device have an outer ring with a north (N) magnetic polarity centered on center 40 and a concentric inner ring with a south (S) magnetic polarity (see, e.g., FIG. 3). Accordingly, when the electronic device is placed on top of the charging puck, the electronic device magnets of FIG. 3 will mate with the corresponding charging puck magnets of FIG. 5 (e.g., each north pole N of FIG. 3 will be aligned with and attracted to a corresponding south pole S of FIG. 5 and each south pole S of FIG. 3 will be aligned with and attracted to a corresponding north pole N of FIG. 5).

Although the arrangement of FIGS. 3, 4, 5, and 6 allows an electronic device to mate with a charging puck, first and second electronic devices with magnets of the type shown in FIG. 3 cannot mate with each other, because when the first and second electronic devices are placed back to back in an attempt to align magnets 26C, the outer ring of north poles of the first electronic device will repel the corresponding outer ring of north poles of the second electronic device. The south poles of the first and second devices will also repel each other when overlapping. As a result, it is not possible to use these alignment magnets to perform alignment and attachment functions for wireless charging between peer devices.

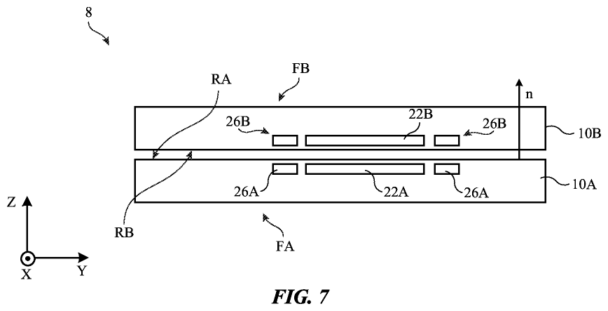

Turning to FIG. 7, devices 10 of system 8 may overcome this challenge by using magnets that attract each other when a pair of devices 10 are placed back-to-back (in at least some rotational orientations of devices 10 around the centers of coils 22). As shown in FIG. 7, device 10A may have magnets 26A (e.g., a ring of magnets) that attract corresponding magnets 26B (e.g., a ring of magnets), even when devices 10A and 10B are oriented as shown in FIG. 7 with back RA of device 10A facing back RB of device 10B. This allows alignment magnets in device 10A to align and attract corresponding alignment magnets in device 10B so that wireless power coil 22B of device 10B is aligned with and electromagnetically coupled to wireless power coil 22A of device 10A.

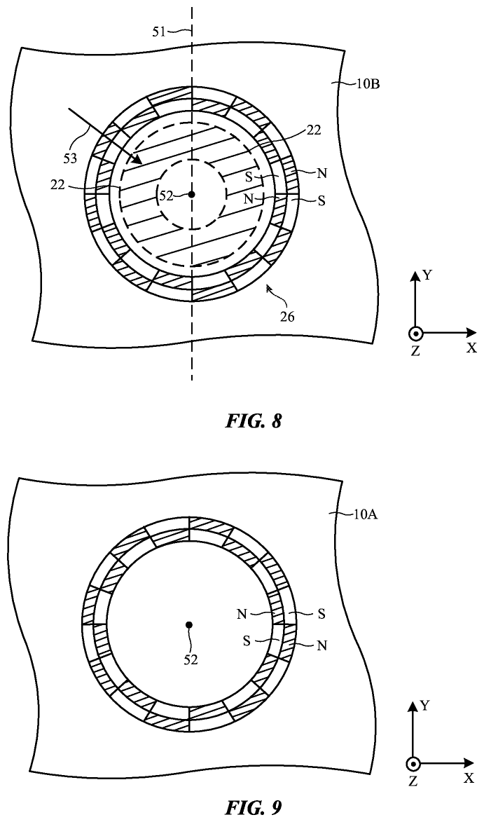

To permit back-to-back alignment and attraction between the alignment magnets in devices 10, devices 10 may have a ring of magnets where the poles of the ring vary as a function of distance around the ring (e.g., poles that alternate as a function of distance around the ring and that therefore alternate as a function of angular position or angle about the center of the ring). FIG. 8 is a front view (view of front FB) of device 10B. FIG. 9 is a rear view (view of rear RA) of device 10A. When it is desired to transfer wireless power between devices 10A and 10B, device 10A may be placed front face down on a table or other surface, as shown in FIG. 7. Device 10B may then be stacked front face up on top of device 10A, as shown in FIG. 7. In this configuration, centers 52 of the magnetic rings of devices 10A and 10B will be aligned.

As shown in FIG. 8, alignment magnets 26 are formed in a ring that includes an outer ring of alternating magnetic poles and a concentric inner ring of magnetic poles. The magnetic axis of each magnet 26 runs through center 52, as shown by illustrative axis (polarity direction) 53. The positions of the magnetic poles exhibit reflection symmetry about axis 51. Axis 51 may coincide with the longitudinal axis along which the housing of a cellular telephone is elongated (as an example). As shown in FIG. 8, axis 51 may bisect coil 22 and the ring of magnets 26 (and the housing of device 10) and may therefore sometimes be referred to as a bisecting axis. Magnets 26 have poles located in pole positions that exhibit reflection symmetry with respect to axis 51 (sometimes referred to as mirror symmetry). The magnetic polarity of the poles reflected about axis 51 are opposite to each other. For example, in a given pole position on the left side of axis 51, a magnetic pole may have a north magnetic polarity. In this situation, there will be a magnetic pole in the reflection of the given pole position on the right side of axis 51 that has a south magnetic polarity.

With this type of magnetic arrangement, the outer ring north poles of magnets 26 of device 10A will be aligned with and will attract the corresponding outer ring south poles of magnets 26 of device 10B when devices 10A and 10B are placed in a back-to-back configuration. The outer ring south poles of magnets 26 of device 10A, which alternate with the outer ring north poles of device 10A will similarly attract the corresponding outer ring north poles of device 10B. This is because the magnetic polarity of the magnetic poles in the outer ring of devices 10 alternate along the outer ring. The inner rings of magnet poles in devices 10A and 10B may likewise mate with each other.

If desired, devices 10A and 10B may be rotated about centers 52 while mating. Not every relative angular orientation between the magnets of devices 10A and 10B about centers 52 will result in a magnet pole in device 10A being aligned with an opposite magnet pole in device 10B. The number of different rotational orientations that allow the magnets of devices 10A and 10B to attract each other relates to the number of different magnet poles around the circumference of the magnet rings. In the examples of FIGS. 8 and 9, the polarity of the magnets alternates 16 times around the circumference of the magnet ring (e.g., the outer ring of poles has 16 alternating north/south poles and the inner ring has 16 alternating south/north poles), allowing devices 10A and 10B to attract each other in every 22.5° of rotation relative to each other about centers 52 (as an example).

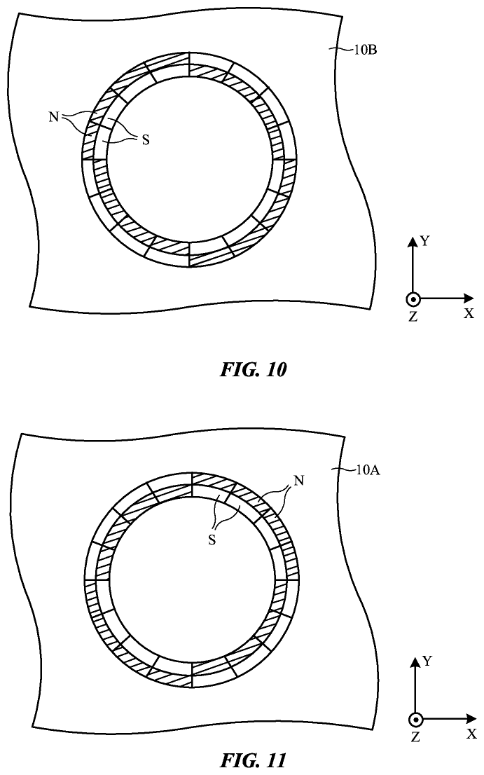

Magnet poles arranged with a coarser pitch around the circumference of the magnet ring will exhibit only a smaller number of mating orientations and magnet poles arranged with a finer pitch around the circumference of the magnet ring will allow more potential orientations in which the alignment magnets of the first and second devices attract each other. In the illustrative example of FIG. 10 (which is a front view of magnets 26 in device 10B of FIG. 7) and FIG. 11 (which is a rear view of magnets 26 in device 10A of FIG. 7), magnets 26 have a coarser pitch (e.g., the polarity of the ring of magnets varies only four times around the circumference of the ring). This type of arrangement allows a pair of back-to-back devices to mate to each other with rotation multiples of 90°. In general, any suitable pole pattern may be used in the magnet rings (e.g., so that rotation multiples of 90° or less or other suitable rotation multiples are permitted).

The ability for a device of a particular model to magnetically align with another device of the same model arises because the magnetic poles of magnets 26 are characterized by pole locations with reflection symmetry about a bisecting axis passing through center 52 (e.g., axis 51, which runs parallel to the Y axis of FIGS. 8 and 9) and magnetic pole polarities that reverse when reflected about axis 51. As a result, the pole location of an alignment magnet that has a given polarity when a given one of devices 10 is face up will have an opposite polarity when that given device (or another device with the same pattern of alignment magnets) is face down.

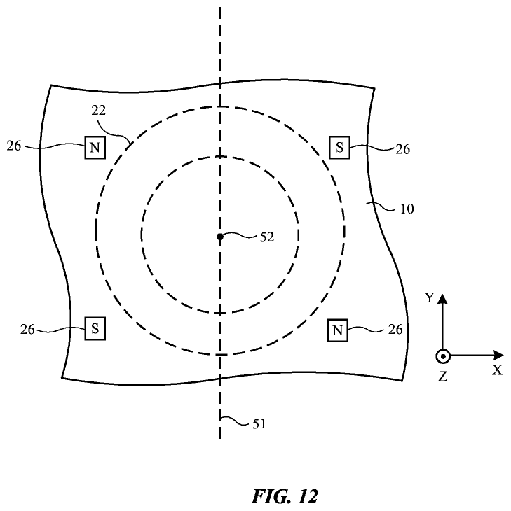

FIG. 12 is an illustrative configuration in which, device 10 has alignment magnets 26 with poles arranged in a square around the outside of coil 22. Magnets 26 (which may be, for example, vertical magnets with polarity directions extending parallel to the Z axis) may have poles that exhibit mirror symmetry about axis 51. With this arrangement the polarity of the N pole in the upper left is opposite to that of its mirror image pole (S) on the upper right and the S pole at the lower left is opposite to that of its mirror image pole (N) on the lower right. As a result, magnets 26 in a pair of devices will attract each other when the devices are placed back to back for wireless power transfer and will allow for 180° rotations. Other arrangements may be used, if desired (e.g., an arrangement with a ring of eight alternating poles to allow for 90° rotations). For example, a single horizontal magnet (or column of magnets) may straddle axis 51 so that a north pole of the magnet is on the left of axis 51 and a south pole of the magnet is on the right of axis 51. Arrangements with other patterns of magnets 26 that exhibit mirror symmetry and that allow varying amounts of permitted rotational alignment when used in a back-to-back configuration may be used, if desired.

In some embodiments, coils 22 may be concentric with rings of alignment magnets (see, e.g., coil 22 of FIG. 8, which is nested within the ring-shaped inner edge of the ring of magnets 26 in FIG. 8). In an arrangement of the type shown in FIG. 12, coil 22 may be surrounded by a set of four magnets 26.

In the examples of FIGS. 8, 9, 10, and 11, magnets 26 are oriented horizontally (with opposing north and south poles lying in the X-Y plane). In horizontal magnets of this type, the north-south pole orientation (e.g., the north-south magnetic pole axis or polarity direction 53 of each magnet) lies in the X-Y plane (e.g., a plane parallel to the plane of the planar rear surface of the housing of device 10) and is perpendicular to the surface normal of the front and rear faces of device 10 (see, e.g., surface normal n of rear face RA of device 10A in FIG. 7).

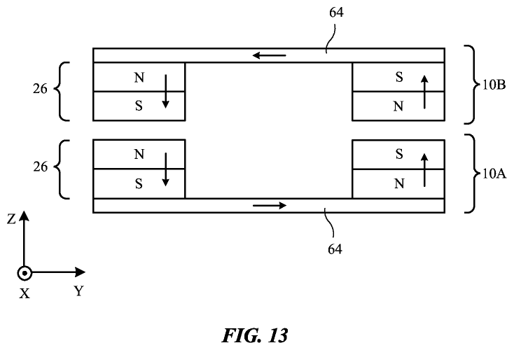

If desired, vertical magnets may be used in alignment magnets 26. For example, magnets 26 may include magnets with magnetic axes that are parallel to the vertical axis (Z axis). The magnets may have pole positions characterized by reflection symmetry about a reflection axis (e.g., a bisecting axis such as axis 51 of FIG. 8) and may be characterized by magnetic polarities that are opposite on opposing sides of the bisecting axis). This type of vertical magnet arrangement is shown in FIG. 13, which demonstrates how this vertical magnet arrangement allows magnets 26 in one device such as device 10A to attract and align to corresponding magnets 26 in another device such as device 10B when devices 10A and 10B are placed back to back with each other. If desired, a layer of ferrite 64 may be included in devices 10 to help direct magnetic flux through magnets 26.

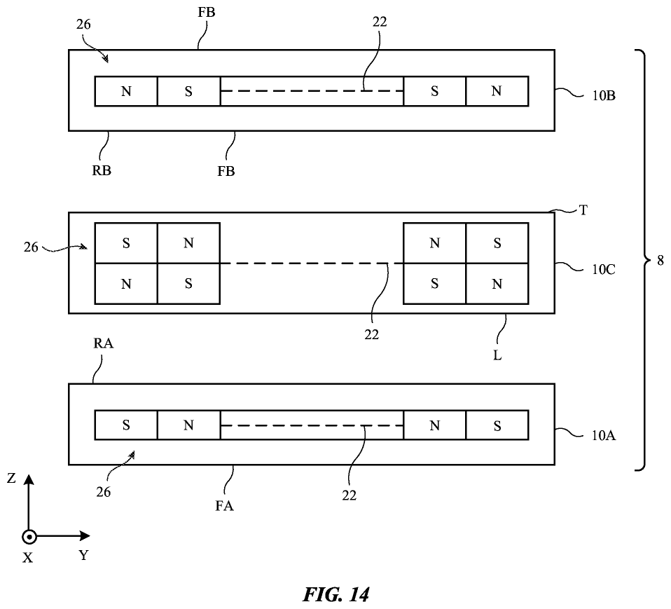

A vertical magnet pattern of this type is shown in FIG. 14. As shown in FIG. 14, the polarity directions of the magnets are parallel to the surface normals of exterior housing surfaces T and L of central device 10C. The alignment magnet pattern of FIG. 14 may be used to allow central wireless power device 10C (e.g., a two-sided charging puck) to be stacked with back-to-back wireless power devices 10A and 10B (e.g., cellular telephones, wristwatches, or other portable electronic devices). Each portable device (10A, 10B) in this example may have a ring of horizontal alignment magnets 26 with poles orientated as described in connection with FIGS. 8, 9, 10 and 11 (as an example). The use of horizontal magnets (magnets with magnetic axes parallel to the X-Y plane) in devices 10A and 10B may help reduce the amount of height (Z dimension) occupied by the magnets.

In two-sided wireless power device 10C of FIG. 14, the vertical orientation of alignment magnets 26 allows one side of device 10C to attract and align with magnets 26 in device 10A while simultaneously allowing another side of device 10C to attract and align with magnets 26 in device 10B. Devices 10A and 10B may be two different devices of the same type (e.g., two devices of the same model of cellular telephone) and/or may be other devices with the same pattern of magnets 26.

If desired, any of these portable devices may be attached to either of the two opposing surfaces T and B of device 10C. For example, device 10A may be magnetically attached to device 10C so that that rear face RA of device 10A faces top surface T of device 10C or may (when flipped upside down) be attached to device 10C so that rear face RA faces lower surface L of device 10C. In either location, the opposing side of device 10C may be unoccupied or may receive another device 10. Wireless charging may be performed by using inverter circuitry in device 10C to drive signals through one or more coils 22 in device 10C, thereby producing wireless power signals 30 that are received by the coil(s) of any aligned and mated devices 10 on top surface T and/or lower surface L.

The foregoing is merely illustrative and various modifications can be made to the described embodiments. The foregoing embodiments may be implemented individually or in any combination.

What is claimed is:

1. A wireless power device configured to pair with external equipment that has an external equipment coil, the wireless power device comprising:
a housing;
wireless power circuitry including a wireless power coil; and
alignment magnets that are configured to align the external equipment coil to the wireless power coil, wherein poles of the alignment magnets are located in pole positions, wherein the pole positions exhibit reflection symmetry about an axis, and wherein each pole at a given pole position has a magnetic polarity that is opposite to that of the pole located in a pole position corresponding to the given pole position reflected about the axis.

2. The wireless power device of claim 1 wherein the wireless power device has a front and rear and wherein the alignment magnets are configured to align the external equipment coil to the wireless power coil at the rear.

3. The wireless power device of claim 2 wherein the rear lies in a plane and wherein the axis is parallel to the plane.

4. The wireless power device of claim 3 wherein the axis comprises a longitudinal axis along which the housing is elongated.

5. The wireless power device of claim 4 wherein the housing comprises a cellular telephone housing and wherein the external equipment coil comprises an additional wireless power coil.

6. The wireless power device of claim 3 wherein the alignment magnets each have north and south poles lying in the plane.

7. The wireless power device of claim 6 wherein the alignment magnets are arranged in a ring surrounding a center.

8. The wireless power device of claim 7 wherein each alignment magnet in the ring has a respective magnetic axis that runs through the center.

9. The wireless power device of claim 8 wherein the ring of alignment magnets has an outer ring of poles that alternate as a function of angle around a center of the outer ring and has an inner ring of poles that alternate as a function of angle around the center.

10. The wireless power device of claim 9 wherein the housing comprises an electronic device housing of a given model of device and wherein the external equipment is of the same given model of device.

11. The wireless power device of claim 9 wherein the alignment magnets are configured to allow the external equipment to mate with the alignment magnets with rotation multiples of 90° or less about the center of the wireless power coil.

12. The wireless power device of claim 11 wherein the alignment magnets are configured to allow the external equipment to mate with the alignment magnets with rotation multiples of 45° or less about the center of the wireless power coil.

13. The wireless power device of claim 9 wherein the wireless power circuitry comprises inverter circuitry configured to supply alternating-current signals to the wireless power coil and comprises rectifier circuitry configured to rectify alternating-current signals from the wireless power coil.

14. The wireless power device of claim 9 wherein the external equipment comprises additional alignment magnets, wherein the alignment magnets are configured to mate with the additional alignment magnets, wherein the additional alignment magnets have additional alignment magnet poles, wherein the additional alignment magnet poles are located in additional alignment magnet pole positions, wherein the additional alignment magnet pole positions exhibit reflection symmetry about an additional axis, and wherein each additional alignment magnet pole at a given additional alignment magnet pole position has a magnetic polarity that is opposite to that of the additional alignment magnet pole located in an additional alignment magnet pole position corresponding to the given additional alignment magnet pole position reflected about the additional axis.

15. The wireless power device of claim 10 wherein the wireless power coil has a center and wherein the alignment magnets are configured to allow only a finite set of discrete rotational orientations between the external equipment and the housing about the center in which the external equipment coil is aligned with the wireless power coil.

16. The wireless power device of claim 15 wherein the external equipment comprises a cellular telephone and wherein the housing comprises a cellular telephone housing.

17. The wireless power device defined in claim 16 wherein the alignment magnets are configured to allow the external equipment to mate with the alignment magnets with rotation multiples of 22.5° about the center of the wireless power coil.

18. The wireless power device defined in claim 16 wherein the alignment magnets are configured to allow the external equipment to mate with the alignment magnets with rotation multiples of 90° about the center of the wireless power coil.

19. A wireless power device of a given model configured to receive wireless power from an external device of the same given model while mated back-to-back with the external device, comprising:
wireless power circuitry;
a housing having a back surface and a front surface; and
magnetic alignment structures configured to align the external device to the housing at the back surface in a back-to-back configuration in which a back housing surface of the external device faces the back surface.

20. The wireless power device of claim 19 wherein the wireless power circuitry comprises a coil, wherein the housing comprises a cellular telephone housing, wherein the external device comprises a cellular telephone, and wherein the magnetic alignment structures are configured to attract the cellular telephone housing against the back housing surface of the external device while wireless power is being received by the coil.

21. The wireless power device of claim 20 wherein the wireless power circuitry comprises inverter circuitry configured to supply alternating-current signals to the coil and comprises rectifier circuitry configured to rectify alternating-current signals from the coil.

22. The wireless power device of claim 21 wherein the alignment magnets are configured to allow the external equipment to mate back-to-back with the cellular telephone housing at angular rotation multiples of 22.5° around a center of the coil.

23. A wireless charging puck operable with portable electronic devices of a given model, comprising:
a housing having first and second opposing sides;
wireless power circuitry including at least one coil, wherein the wireless power circuitry is configured to transmit wireless power signals through the first and second sides; and
a ring of alignment magnets configured to mate with a first of the portable electronic devices of the given model on the first side while simultaneously mating with a second of the portable electronic devices of the given model on the second side.

24. The wireless charging puck of claim 23 wherein the ring of alignment magnets comprises a plurality of magnets that each have a magnetic pole axis parallel to a surface normal of the first side.

25. The wireless power device of claim 24 wherein the alignment magnets are configured to:
allow the first of the portable electronic devices to mate with the housing at angular rotation multiples of 90° or less about the center; and
allow the second of the portable electronic devices to mate with the housing at angular rotation multiples of 90° or less about the center.
